(19) United States
(12) Patent Application Publication
(10) Pub. No.: US 2019/0034592 A1
(43) Pub. Date: Jan. 31, 2019

(54) ELECTRONIC HEALTHCARE RECORD ANALYSIS AND MEDICAL TREATMENT ASSESSMENT SYSTEMS AND METHODS

(71) Applicants: Atul Gupta, Grimes, IA (US); Meenesh Arun Bhimani, Fremont, CA (US)

(72) Inventors: Atul Gupta, Grimes, IA (US); Meenesh Arun Bhimani, Fremont, CA (US)

(21) Appl. No.: 15/658,599

(22) Filed: Jul. 25, 2017

(51) Int. Cl. G06F 19/00

(52) U.S. Cl. CPC G06F 19/327; G06F 19/3481; G06F 19/322

(57) ABSTRACT

Health care record analytic and medical treatment assessment systems and methods include at least one processor-based device configured to identify a medical condition or treatment action item and facilitate its completion in a desired timeframe.

### BACKGROUND OF THE INVENTION

The field of the invention relates generally to electronically implemented systems and methods for administrating and managing medical treatment facilities, and more specifically to an electronically implemented healthcare record analysis and medical treatment assessment system and methods to improve medical treatment outcomes and ensure optimal patient treatment conforming with best medical practices.

Modern medical treatment facilities face a complex set of issues from a management perspective. Assessing and evaluating a real-time performance of a number of physicians, nurses, nurse practitioners and other medical personnel or medical staff at a treatment facility raises a number of practical challenges. From patient intake to release, optimizing patient treatments and minimizing treatment time per patient facilitates the most efficient use of medical care facility resources, but achieving desired efficiency and efficacy remains elusive in some aspects. Improvements are desired.

### BRIEF DESCRIPTION OF THE INVENTION

In one embodiment, a health care record analytic and medical treatment protocol system is provided including at least one processor-based device configured to: analyze an electronic health care record of at least one patient at a first point in time, identify a medical treatment action item in view of the analyzed electronic health care record, and prompt a user confirmation of the identified medical treatment action item. If the identified medical treatment action item is confirmed, the at least one processor-based device is also configured to: set a countdown timer for performance of the identified medical treatment action item, and await user confirmation that the identified medical treatment action item is completed before the expiration of the countdown timer.

In another embodiment, a health care record analytic and medical treatment protocol method is provided. The method is implemented with at least one processor-based device, and the method includes analyzing, by the at least one processor-based device, an electronic health care record of at least one patient at a first point in time, identifying a medical treatment action item in view of the analyzed electronic health care record and prompting a user confirmation of the identified medical treatment action item. If the identified medical treatment action item is confirmed, the method further comprises setting a countdown timer for performance of the identified medical treatment action item, and awaiting user confirmation that the identified medical treatment action item is completed before the expiration of the countdown timer.

In another embodiment, a non-transitory computer readable medium that includes computer executable instructions for electronically analyzing patient health care records and performance of medical treatment protocols is provided. When executed by at least one computing device having at least one processor in communication with a memory device, the computer executable instructions cause the at least one computing device to analyze an electronic health care record of at least one patient at a first point in time, identify a medical treatment action item in view of the analyzed electronic health care record, and prompt a user confirmation of the identified medical treatment action item. If the identified medical treatment action item is confirmed, the computer executable instructions also cause the at least one computing device to set a countdown timer for performance of the identified medical treatment action item, and await user confirmation that the identified medical treatment action item is completed before the expiration of the countdown timer.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a simplified block diagram of an exemplary embodiment of a health care record analytic and treatment assessment system according to an exemplary embodiment of the invention.

FIG. 2 is a method flowchart of processes executed by the health care record analytic and treatment assessment system shown in FIG. 1.

### DETAILED DESCRIPTION OF THE INVENTION

Modern day medical facilities such as hospitals, outpatient treatment centers, and urgent care centers, among others, raise complex management issues and challenges that in combination may sometimes lead to sub-optimal results in certain aspects.

Well-trained medical staff, including but not necessarily limited to physicians, nurses, and nurse practitioners are well-versed in providing accepted medical treatment protocols to treat patients having certain conditions. For a variety of reasons, however, efficiently diagnosing a condition of any given patient is sometimes challenging.

For example, the most relevant information for making a patient diagnosis may not always be at hand, may not be effectively communicated by the patient or another medical provider, or may not be fully understood during patient intake or admission procedures. In a fast-paced medical environment involving rapidly changing priorities and competing interests of different patients, limited information and limited amounts of time for medical personnel to make diagnoses and treatment decisions can sometimes contribute to misdiagnosis and/or patient treatments that are not as effective as desired. Improving speed and accuracy of a proper diagnosis so that correspondingly optimal treatment plans can be implemented would be beneficial to patients and medical facilities alike. Particularly for larger hospitals and emergency room environments involving larger numbers of patients being simultaneously seen under rapidly evolving circumstances with limited resources, speed and accuracy of patient diagnosis is of paramount concern.

Electronic health care records and systems exist that provide greater portability and access to complete patient information by different healthcare providers and persons. Electronic health care records may better inform or illuminate the proper diagnosis of a patient's condition, but fully reading and comprehending the full electronic record in a limited period of time is sometimes challenging. In instances wherein the health care record is supplemented, changed, modified, or corrected while the patient is in the facility and as treatment progresses, at any given time the most relevant information needed to assess the patient or the state of treatment may not yet be reflected in the record at the time that it is being consulted by medical personnel. As a result, to many medical personnel and medical organizations, the most productive utilization of electronic health care record information has yet to be realized.

Once a diagnosis is made for a particular patient, appropriate medical treatment protocols may be invoked. While in most cases the medical personnel attending to a patient is able to implement the applicable treatment protocol(s) properly and timely, at least some medical facilities lack an objective and a cost effective means to confirm that the protocols are actually accomplished in real time. Accordingly, if for any reason the treatment protocol is delayed (i.e., medical personnel fails to timely start or timely continue the proper treatment protocol by performing necessary steps), such delayed treatment may be undetected for some period of time. Again, and particularly for larger hospitals and emergency room environments wherein large numbers of patients are being simultaneously treated under rapidly evolving circumstances with limited resources, attending to competing priorities of different patients, delays in beginning treatment protocols or completion of treatment protocols for one or more patients may be somewhat more likely.

While typically correctable once detected, such delays in implementing protocols in the first instance, or any delay in detecting and correcting aspects of delayed steps in completing a particular protocol, leads to extended patient treatment times and/or increased time before the patient actually benefits from proper treatment. Most patients lack medical training or medical knowledge and accordingly are not well-positioned to provide meaningful feedback to medical personnel so that such issues can be more effectively managed. It is therefore typically up to the attending medical personnel to self-correct when issues arise, and while they most often do the timeframe to self-correct may vary considerably. Particularly for larger hospitals and emergency room environments wherein large numbers of patients are being simultaneously treated, delays in detecting and correcting sub-optimal execution of protocols may have a cascading effect across a number of patients being treated, and also patients in waiting that have yet to be seen and evaluated by medical personnel. Unreasonably long wait times before patients can be evaluated, and/or unreasonably extended time periods before treatment starts to improve a patient's condition are undesirable from the perspective of patients, medical staff, and facility administrators. Proactive management tools facilitating more consistent delivery of optimal patient processing treatment has so far been elusive.

From an administrative perspective, payment for medical services provided to patients is sometimes contingent on the effectiveness of the medical services provided. For example, the Centers for Medicare & Medicaid Services (CMS) has adopted a system wherein a relative value of services performed by different healthcare providers is determined using a composite score that factors in different weighted performance categories. The overall composite score of any given provider is accordingly utilized as a performance measure that is compared to composite scores of other medical service providers as peers across a number of different criteria. Medical providers having higher composite scores may be paid more money by CMS for their services provided than other providers having lower composite scores. Also, higher composite scores may render it more likely that the provider will be selected by patients for treatment relative to other providers having lower composite scores or rankings. On the other hand, providers that do not meet minimum threshold scores may receive a substantial reduction in payments from CMS. Excessive delays in proper diagnosis and treatment of patients may negatively affect the composite scores of participating providers, and payment reductions because of lower composite scores attributable to such delays are therefore of concern to any medical practice. In many instances treatment efficacy impacts the financial health of the facility and imposes practical constraints on the ability to deliver desired results. Proactive management tools to increase efficacy in the aspects discussed above are accordingly desired.

Additionally, patients having sub-optimal experiences in any given treatment facility may be less likely to return for future services, and across a large number of patients there may be financial repercussions to the medical facility if sub-optimal experiences cannot be proactively managed. From the perspective of the patient, the most efficient treatment is generally the best treatment. The patient will be evaluated sooner for a diagnosis, be treated more quickly, start to feel better more quickly, and ultimately be discharged from the medical facility in the least amount of time if the most efficient treatment can be delivered. Patients that are well-served and satisfied are likely to return to the facility for additional services when needed and/or to recommend others to the facility, while patients that are dissatisfied are less likely to return or recommend the facility to others. The reputation of the facility from a patient's perspective is accordingly a vital part of a healthy and sustainable medical practice.

Likewise, minimizing a treatment time per patient from patient intake to release facilitates the most efficient use of medical care facility resources and allows the most patients to be treated with the resources at hand. Any delay in making an accurate diagnosis, delays in commencing treatment of patients per the proper treatment protocol, or delays in completion of the proper treatment protocol undesirably reduces efficiency of the facility. Many treatment facilities, however, are not well-equipped to detect such inefficiencies as they occur to facilitate a more proactive management approach.

Improved health care record analytic and treatment assessment systems and methods are described below that advantageously overcome the issues described above. The systems and methods utilize automated health care record analysis and comparison of diagnoses and treatments made (or not made) to information in health care records for real-time analysis and confirmation by medical personnel to ensure that the treatment protocols adopted by each medical facility may be efficiently realized, or so that corrective actions may be triggered by the systems in real time as inefficiencies are detected. Beneficially, the systems and methods of the invention more quickly facilitate a determination or confirmation of a diagnosis for each patient, identify a questionable diagnosis for further review, confirm a timely implementation of the proper medical treatment protocol without excessive delay, and identify or detect non-compliance issues in efficiently completing treatment protocols for prompt response and correction.

Notifications and alerts may be provided by the systems and methods of the invention to various different medical personnel at different locations in the treatment facility. The notifications and alerts may concern patient treatment actions that should be taken or that have not been undertaken within predetermined time limits corresponding to the applicable medical treatment protocol. The system implements countdown timers for each step of a treatment protocol and communicates to medical personnel that necessary action items relating to each step of a treatment protocol are not complete until a member of the health care provider team confirms completion of the protocol in a step-by-step manner. Real-time confirmation and feedback is made available in a distributed manner to medical personnel at different locations to allow proactive treatment facility management to ensure that proper treatment protocol measures are timely taken, ensure that treatment protocol action items that are not timely completed are identified, and communicate status information sot that corrective measures may be immediately taken. Data archiving and report generation may be provided in the system for analytical purposes, troubleshooting purposes, or as evidence of compliance with best practices and procedures and demonstrate treatment efficacy to interested persons, including but not limited to a contingent payment provider.

By virtue of the systems and methods of the invention, sub-optimal aspects of patient diagnoses and treatment may be detected and identified by the system as they occur, and any corrective measures needed may be made in real-time in view of the system notifications to avoid treatment delays, improve patient treatment outcomes, improve the performance of medical personnel, improve or maintain high composite scores for payment of services provided, and facilitate the most efficient allocation of facility resources. The systems and methods of the invention accordingly fulfill longstanding and unresolved needs of healthcare facility administrators and managers.

The technical problems addressed by the systems and methods of the invention of the invention include at least one of: (i) lack of electronic tools to most efficiently consider changes in electronic health care record data while evaluating or treating a patient in a medical facility; (ii) lack of electronic tools addressing human inability to reliably perform and confirm timeliness of medical protocol treatment steps over a number of patients; (iii) lack of electronic tools addressing human inability to detect excessive delays in treatment steps of individual patients over a group of patients being simultaneously treated; (iv) lack of electronic tools addressing human inability to communicate treatment delays to managers and others who may take corrective actions in real time; (v) lack of electronic tools addressing human inability to assess performance of medical teams in real time while attending to a group of patients; (vi) lack of electronic tools addressing human inability to reliably compile data for study and analysis concerning medical facility resources; (vii) lack of electronic tools addressing human inability to minimize patient treatment time over a group of patients presenting rapidly changing priorities and needs; and (viii) lack of electronic tools with self-learning capabilities to complement and improve the performance of a medical team in the least obtrusive manner possible.

The systems and methods of the invention may be implemented using computer programming or engineering techniques including computer software, firmware, hardware, or any combination or subset thereof, wherein the technical effects may be achieved by: (i) providing electronic tools to iteratively analyze electronic health care records at predetermined time intervals, and identify, material changes in the electronic health care records for patients being treated; (ii) electronically presenting an identified possible diagnosis for confirmation by medical personnel and adaptively self-adjusting identification of possible diagnoses in view of feedback from medical personnel; (iii) electronically time a performance of medical protocol treatment steps over a number of patients; (iv) electronically identify delays in treatment steps of individual patients over a group of patients being simultaneously treated; (v) electronically communicate treatment delays to managers and others who may take corrective actions in real time; (vi) electronically compile performance data of medical teams in real time while attending to a group of patients; (vii) electronically compile data and generating reports for study and analysis concerning medical facility resources; (viii) electronically assist and improve utilization of electronic health care records with self-learning capabilities to complement the performance of a medical team in the least obtrusive manner possible and improve patient treatment outcomes over a group of patients presenting rapidly changing priorities and needs.

The resulting technical benefits achieved by the methods and systems of the invention include at least one of: (i) iterative and electronic analysis of electronic health care records at predetermined time intervals to assess changes in the electronic health care records that may facilitate a more effective treatment protocol for patients seeking treatment; (ii) electronical consideration of historical feedback from medical personnel while electronically analyzing electronic health care records to improve an electronic identification of the most accurate possible treatment protocol over time; (iii) automatic implementation of electronic countdown timers to complete medical protocol treatment steps over a number of patients in a preferred time frame; (iv) automatic and electronic identification, via the countdown timers, of delays in treatment steps of individual patients over a group of patients being simultaneously treated; (v) automatic and electronic communication of treatment delays to managers and others who may take corrective actions in real time; (vi) electronic compilation of performance data of medical teams in real time while attending to a group of patients; (vii) electronic compilation of data and report generation for study and analysis concerning medical facility resources; (viii) electronically enhancing a utilization of electronic health care records with self-learning capabilities to complement the performance of a medical team in the least obtrusive manner possible and improve patient treatment outcomes over a group of patients presenting rapidly changing priorities and needs.

The systems and methods of the invention and their technical effects and technical benefits may be implemented using computer devices and computer programming or engineering techniques including computer software, firmware, hardware or any combination or subset thereof, wherein the technical effects described above are achieved. Such programs include computer-readable code that may be embodied or provided within one or more computer-readable media in an article of manufacture such as, but not necessarily limited to a fixed (hard) drive, a diskette, an optical disk, a magnetic tape, a semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

As for the purposed of description herein, the terms “computer program”, “programs”, “software”, “software applications”, “apps”, or “code” include machine instructions for a programmable processor, and can be implemented in a high-level procedural and/or object-oriented programming language, and/or in assembly/machine language. The terms “machine-readable medium” “computer-readable medium” in the present description refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” instead refers to any signal used to provide machine instructions and/or data to a programmable processor.

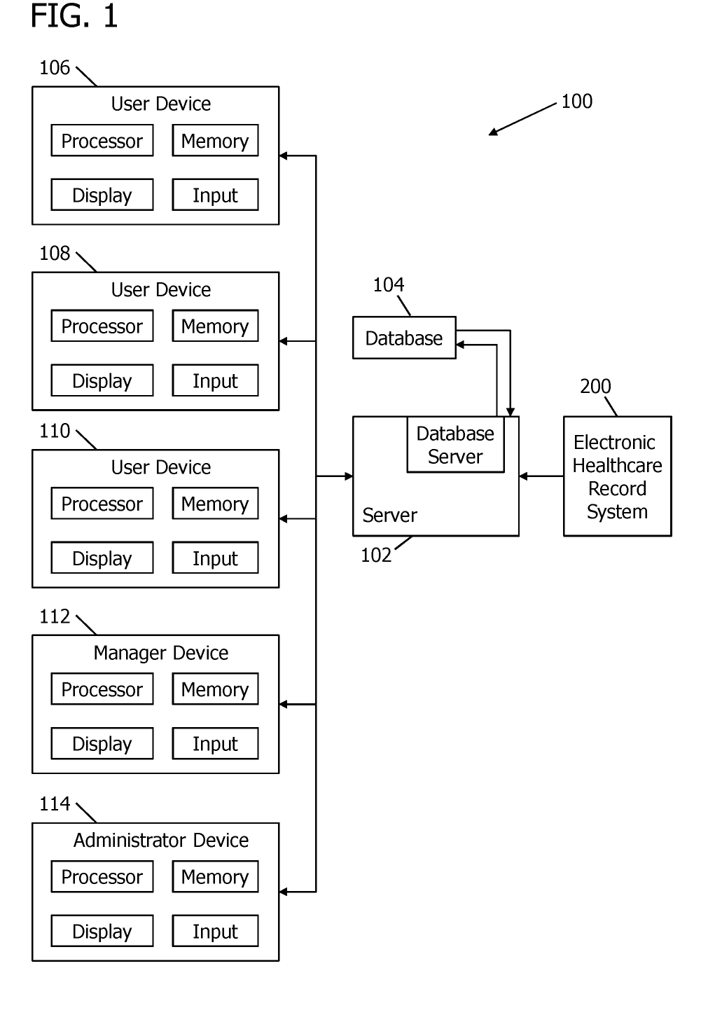

FIG. 1 illustrates aspects of an exemplary embodiment of a health care record analytic and medical treatment assessment system 100 according to the present invention. The system 100 in the example of FIG. 1 is utilized in combination with a separately provided and computer-implemented electronic health record (EHR) system 200 that pre-exists in most medical treatment facilities. As such, the system 100 is a complement to the EHR system 200 rather than a replacement to the EHR system 200. In other words, the health care record analytic and medical treatment assessment system 100 of the invention as shown in FIG. 1 is an independently running, stand-alone system operating alongside the EHR system 200. The stand-alone nature of the system 100 is beneficially in that it allows customization of the system 100 to meet varying needs of each medical facility. That is, the system 100 may be tailored to meet the unique needs or desires of a specific medical treatment facility and accordingly two systems 100 in different medical treatment facilities may operate differently from one another depending on the needs or preferences of each treatment facility.

In general, EHR information for patients is entered or otherwise accepted by and stored in the EHR system 200 with appropriate security measures to safeguard the information and patient privacy according to state and federal laws. Importantly, in the illustrated example, for operation of the health care record analytic and medical treatment assessment system 100 pertinent EHR information is requested from or extracted from the EHR system 200 for analysis for particular patients present and being seen at the treatment facility where the system 100 resides, but the EHR information and data is undisturbed by the system 100. In other words, and by design, the EHR information and data can only be entered, updated or altered via the EHR system 200 to ensure the integrity and protection of the EHR information and data, while the health care record analytic and medical treatment assessment system 100 operates according to the EHR information and data obtained via the EHR system 200. It is recognized that in some cases, however, the system 100 and the EHR system 200 could effectively be combined if desired.

The EHR system 200 is shown in simplified form in FIG. 1 as a single device, although it may alternatively include multiple processor-based computer devices in a network including servers communicating with databases and any number of workstations, personal computers, or laptop or notebook computers for various different users in patient intake processes wherein EHR information and data is entered, accepted, obtained, or updated in the EHR system 200 as patients arrive and are being evaluated at the medical facility. Additionally, personal hand-held devices such as tablet computers and smart phones may communicate with the EHR system 200 as necessary or as desired inside the medical facility for use by medical personnel. Wireless and non-wireless communication networks and techniques may be utilized to establish communication between devices in the system 200 or allowing the EHR system 200 to communicate with separate devices or systems, including but not necessarily limited to the health care record analytic and medical treatment assessment system 100. Cloud-based storage and access is also possible in the EHR system 200 as desired. Communication interfaces in the devices of a networked system 200 are known to facilitate wired or wireless communication between the devices according to known protocols.

The health care record analytic and medical treatment assessment system 100 of the invention, as described in detail below, accepts or extracts EHR information and data from the EHR system 200 and analyzes the electronic health record data via rule-based algorithms and the like described below. The information and data formatting/structure of records in the EHR system 200 is known and understood by the system 100, such that the system 100 can read or interpret the electronic health care records for analysis. In contemplated examples, the EHR system 200 stores data and information in a predetermined structure and the health care record analytic and medical treatment assessment system 100 analyzes the data and information without changing its structure. In other embodiments, appropriate data conversion may be made by the health care record analytic and medical treatment assessment system 100 such that the system 100 re-structures the data and information from the system 200 into an optimized structure for use by the system 100. As explained below, the health care record analytic and medical treatment assessment system 100 not only analyzes the EHR data and information, but learns from analysis previously undertaken in view of feedback by medical personnel. As such, the system 100 in performing its analysis of EHR data and information is not limited to the EHR data and information itself that is provided by the EHR system 200, but may include other data and information that the system 100 has learned over time.

In the example shown, the health care record analytic and medical treatment assessment system 100 includes at least one processor-based server device 102, at least one database 104 in communication with the server device, and a number of processor-based user devices 106, 108, 110, 112 and 114 in communication with the at least one server device 102. While one server 102, one database 104 and five devices 106, 108, 110, 112 and 114 are shown in the example of FIG. 1, greater or fewer numbers of devices may be provided. In some embodiments of the health care record analytic and medical treatment assessment system 100, certain of the devices 102, 104, 106, 108, 110, 112 and 114 may be considered optional and may be omitted. As such, the system 100 may include any number of devices and combinations of devices to meet the particular needs of a particular medical treatment facility. The system may be flexibly implemented in various architectures including different numbers of devices and in varying degrees of redundancy and sophistication.

The database 104 in contemplated embodiments includes comprehensive medical treatment diagnosis, comprehensive treatment protocol data, and related algorithms such as those described below that facilitate analysis of the EHR data and information itself patient-by-patient at the medical treatment facility as those patients are being seen, evaluated, and treated. The analysis may include an identification or recommendation of a patient diagnosis based on the content of the EHR data and information, an identification of a medical treatment protocol for a diagnosed patient, and step-by-step instructions and target completion time information for treatment protocols corresponding to each respective diagnosed patient at the treatment facility. Such identified diagnoses and treatment protocols by the system may relate to, but are not limited to, so-called “core measures” of CMS that are utilized to create a composite score for the treatment facility and medical practice as described above.

In different embodiments, the database 104 in the health care record analytic and medical treatment assessment system 100 may be centralized and stored on the server system 102. The database 104 may be accessed by potential users by logging onto the server system 102 through another one of the devices described below. In an alternative embodiment, the database may be stored remotely from server system 102 and may be non-centralized. Multiple servers 102 and multiple databases are contemplated in some embodiments, with each server running unique algorithms requiring different data that may be in different databases.

The health care record analytic and medical treatment assessment system 100, via the algorithms provided, can identify and assess treatment protocols patient-by-patient and step-by-step in real time until the applicable protocols are completed. The algorithms may also provide informational feedback to medical personnel regarding action items needing to be taken for particular patients, an amount of time to preferably complete each of those action items, and accept confirmation of completed action items by medical personnel. In doing so, the system 100 collects data regarding the actual performance of medical personnel in real time that facilitates meaningful evaluation by medical facility managers and administrators. A more proactive management of the medical facility is therefore made possible by the data and report generation capabilities of the system 100. Alerts can be generated by the system 100 in real time to improve performance, minimize delays, and minimize mistakes in completing the pertinent treatment protocols. Additionally, detailed reports may be generated by the system 100 via data stored and archived on the system 100 to assess strengths and weaknesses of treatments made in the facility overall, as well as to easily provide documentation of treatment efficacy upon request or as desired.

In the example of FIG. 1, the devices 106, 108 and 110 are indicated as “user devices” that for purposes of the present description correspond to the medical team that is on duty at the site of the treatment facility and is actually attending to the patients at the facility. As such, the user devices 106, 108 and 110 are utilized by medical personnel and staff in the general vicinity and location where each patient is present and is actually being treated.

In the example of a medical treatment facility such as a hospital, the user devices 106, 108 and 110 may be located on different floors or in different areas of the hospital where different treatment options or specialist personnel may be assigned. For example, the user device 106 may be located in a first ward of the hospital assigned and equipped to treat patients having a common condition of a first type, the user device 108 may be located in a second ward of the hospital assigned and equipped to treat patients having a common condition of a second type, and the user device 108 may be located in a third ward of the hospital assigned and equipped to treat patients having a common condition of a third type. The functionality of the user devices in each ward may be customized in view of the particular and different needs of each ward. Also, each ward may include multiple user devices as desired or as needed. The devices in each ward may communicate with different servers and/or databases in the system 100 as each ward presents different issues and needs. It should be realized, however, that different wards or areas and respectively different user devices are not required for the benefits of the system 100 to be realized.

The devices 112 and 114 are indicated in FIG. 1 as a manager device and an administrator device, respectively. While one of each is shown in FIG. 1, multiple manager devices and/or administrator devices may be provided at desired locations throughout the medical treatment facility or as desired in locations remote from the medical treatment facility. Via the management device(s) 112 or administrator devices 114, real time alerts may be received by managers of the medical staff who may intervene or take corrective actions when notified by the system 100, and administrators may be provided data to analyze the overall efficiency, productivity, and efficacy of the medical treatment facility and make informed judgments regarding possible improvements.

Informational feedback may also be made available via the management device(s) 112 and/or administration devices 114 regarding treatment action items due on a per patient basis, treatment action items completed on a per patient basis, and responsiveness of medical staff to the system 100 on an individual or group basis. The management device(s) 112 are not necessarily floor specific or ward specific in the medical treatment facility, and may therefore include more comprehensive information and capabilities than the user devices described above. In some embodiments wherein the managers in each ward are provided a user device 106, 108 or 110 as described above, a separate manager device 112 may be redundant and considered optional. Also, in some cases the administrator device 114 may also be considered optional.

In general, and as shown in the example of FIG. 1, each device 106, 108, 110, 112, 114 is a computing device including a microprocessor, a memory, a display and an input device for the user to communicate with each device and the larger system 100. In various different embodiments, the devices 106, 108, 110, 112, 114 may be provided in the form of computer workstations, personal computer or desktop devices, portable laptop or notebook computer devices, mobile tablet devices or smartphone devices. In some embodiments, other types of processors such as central processing units, microprocessors, microcontrollers, reduced instruction set circuits (RISC), application specific integrated circuits (ASIC), logic circuits, and any other circuit or processor capable of executing the functions described herein may be utilized in each device 106, 108, 110, 112, 114 in lieu of the microprocessor shown. The term “processor-based device” as used herein shall include any of the devices/structures above or otherwise known in the art to deliver the functionality described herein.

Each device 106, 108, 110, 112, 114 is further provided with “software” or “firmware” that are interchangeable terms referring to any computer program stored in the memory of each device for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

The display in each device 106, 108, 110, 112, 114 may include an electronic display screen of any desired size. Exemplary types of display screens include a liquid crystal display (LCD), an organic light emitting diode (OLED) display, an “electronic ink” display or another type of display screen known in the art. The display screen may be a desktop monitor, a wall mounted screen, or a portable display screen that is built-in to the device. More than one display may be provided for use by any particular user/person. The displays in the system 100 are sometimes referred to as “dashboards” for quick reference by the desired users/persons. Such dashboards may display the same or different information to specific users at various locations in the medical treatment facility.

The input element of each device 106, 108, 110, 112, 114 may include a keyboard, a mouse or other input element allowing a user/person to interact with the device. In some cases, the display in each device 106, 108, 110, 112, 114 may be a touch sensitive screen with built-in capability to receive inputs, such that a separately provided input element may be considered optional.

In various embodiments, the system 100 and its devices 102, 104, 106, 108, 110, 112, 114 may be run in a Windows® environment (Windows is a registered trademark of Microsoft Corporation, Redmond, Wash.), may be run on a mainframe environment and a UNIX® server environment (UNIX is a registered trademark of X/Open Company Limited located in Reading, Berkshire, United Kingdom), may be run on an iOS® environment (iOS is a registered trademark of Apple Inc. located in Cupertino, Calif.), or may be run on a Mac OS® environment (Mac OS is a registered trademark of Apple Inc. located in Cupertino, Calif.). Combinations of different devices running in different operating environments are possible in the system 100.

The system 100 may also include one or more software applications (i.e., a service app) installed on one or more of the devices 106, 108, 110, 112, 114 described. The system application is accordingly flexible and designed to run in various different environments without compromising any major functionality. A set of servers 102 may be located throughout the hospital facility with the devices communicating with specified ones of the servers and dashboard screens provided for different users. Alternatively, the server or servers may be hosted in the cloud.

In some embodiments, the system includes multiple components distributed among the plurality of computing devices 102, 104, 106, 108, 110, 112, 114. One or more components are in the form of computer-executable instructions embodied in a non-tranistory computer-readable medium. The systems, components, and processes are not limited, however, to the specific embodiments described herein. Also, components of each system and each process can be practiced independently and separately from other components and processes described herein. Each component and process can also be used in combination with other assembly packages and processes.

In one embodiment, a computer program is provided in the system 100, and the program is embodied on a computer-readable medium and utilizes a Structured Query Language (SQL) with a client user interface front-end for administration and a web interface for standard user input and reports. In another embodiment, the system 100 is web-enabled and is run on a business entity intranet. In yet another embodiment, the system 100 is fully accessible by individuals having an authorized access outside the firewall of the business-entity through the Internet. Computerized modeling and grouping tools are stored in the server system 102 and can be accessed by a requester at any one of the devices 106, 108, 110, 112, 114. In one embodiment, the devices 106, 108, 110, 112, 114 are computers or other electronic devices including a web browser, such that the server system 102 is accessible to the devices 106, 108, 110, 112, 114 using, for example, the Internet. The devices 106, 108, 110, 112, 114 may be interconnected to the Internet through many interfaces including, for example, a network such as a local area network (LAN) or a wide area network (WAN), dial-in-connections, cable modems and special high-speed ISDN lines. As mentioned above, the devices 106, 108, 110, 112, 114 may be any type of device capable of interconnecting to the Internet including a web-based phone, personal digital assistant (PDA), or other web-based connectable equipment or equivalents thereof.

Communication between the devices 102, 104, 106, 108, 110, 112, 114 in the system 100 may also be established via communication interfaces that may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN). Each device 106, 108, 110, 112, 114 may also include a microphone, an audio output device, a speaker or headphones as desired.

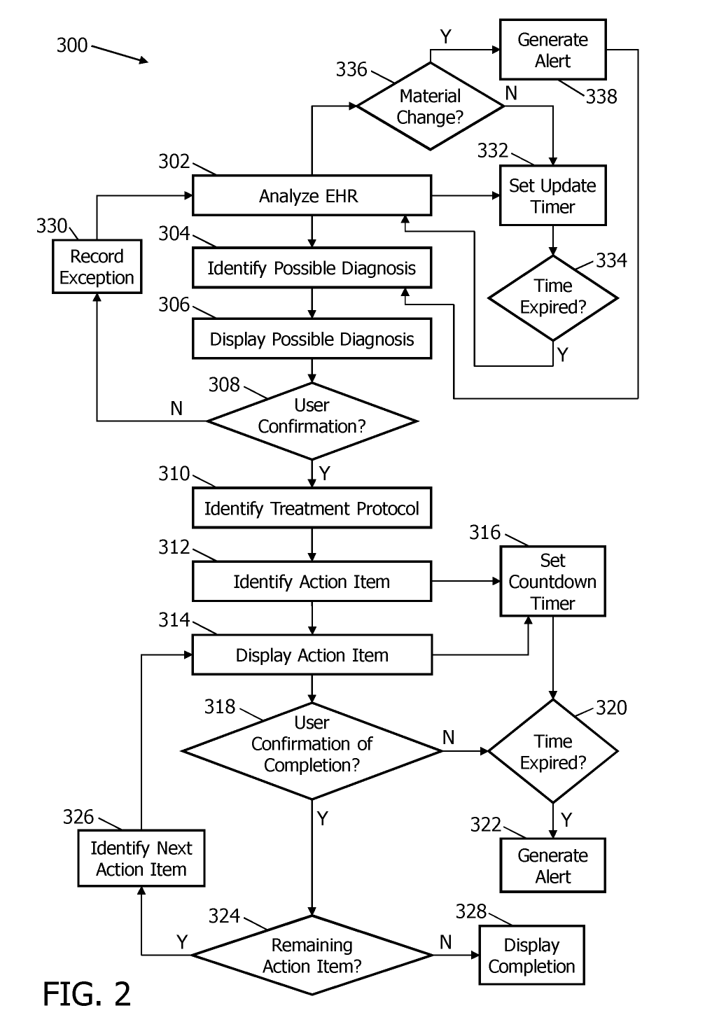

FIG. 2 is a method flowchart of processes 300 executed by the health care record analytic and treatment assessment system 100 shown in FIG. 1. The processes 300 assume the installation and connection of the devices in the system 100 described above as configured or programmed to achieve the technical benefits described.

At step 302, electronic health care records of specific patients present at the medical facility for treatment are analyzed. The analyzed records may be, as described above, retrieved or extracted from the EHR system 200. The analysis at step 302 may include rule-based computer logic analysis to identify keywords found in each electronic health care record for each patient that are important to making an accurate diagnosis. Keyword analysis in the respective electronic health care records may be made in reference to predetermined diagnosis and treatment profiles stored in the system 100. Specifically, the keyword analysis may correspond to terminology found in the ICD9/ICD10 entries of the International Classification of Diseases (ICD), and the system 100 may look for keyword matches between the electronic health care records and the ICD9/ICD10 entries. The analysis at step 302 may be conducted by the server 102 using the database 104, or by the devices 106, 108, 110, 112, 114 communicating with the server 102 or database 104. In some cases, the analysis at step 302 could be performed by one or more of the devices 106, 108, 110, 112, 114 using information and algorithms stored on each respective device.

At step 304, a possible diagnosis of a condition for each patient is identified by at least one of the described devices in the system 300. Following the example contemplated above, the identification at step 304 corresponds to a most likely match made between keywords in the analyzed electronic health record and keywords in one of the predetermined diagnosis and treatment profiles stored in the system 100. Certain of the predetermined diagnosis and treatment profiles may be quickly eliminated by the absence of keywords in the analyzed electronic health record, while others may require consideration of multiple keywords or other factors in order to identify the most likely possible diagnosis. The identification of the possible diagnosis may be made by one of the devices described in the system 100 (e.g., the server 102) and communicated to other devices (e.g., the devices 106, 108, 110, 112, 114) in the system 100.

At step 306, the system 100 displays the identified possible diagnosis made at step 304 via one or more of the dashboards provided in the devices 106, 108, 110, 112, 114 in the example of FIG. 1. At step 308, the system awaits confirmation of the identified possible diagnosis displayed at step 306 by a member of the medical team utilizing the input element of a user device 106, 108, 110 in the system 100. In some instances, additional data in the electronic health care record may confirm the diagnosis and the confirmation shown at step 308 may be omitted. Optionally, when a confirmation is requested at step 308, a countdown timer may be set and displayed via one or more of the user devices 106, 108, 110 and an alert may be generated if the countdown timer expires without the diagnosis being confirmed in a desired timeframe.

If the identified possible diagnosis displayed is confirmed by one of the users using one of the user devices 106, 108, 110 in the system 100, (or if confirmation is not requested) the system proceeds at step 310 to identify the treatment protocol corresponding to the confirmed diagnosis. The system may do so by retrieving the treatment protocol associated with the diagnosed condition according to the predetermined diagnosis and treatment profiles stored on the system 100. The predetermined diagnosis and treatment profiles stored on the system 100 are customized to each medical treatment facility according to their own needs and preferences in contemplated examples.

In some embodiments of the system 100, the system need not suggest a diagnosis as described above, but instead treatment providers may input a diagnosis via one of the system devices to start a treatment pathway. Such input may be made in any manner desired as long as the system can use the input to identify the correct treatment protocols. In another embodiment, the system may allow a treatment provider to input a diagnosis as an alternative to a possible diagnosis identified by the system. Such input of a diagnosis may be deemed as a rejection of the possible diagnosis identified by the system. The process may proceed once the input diagnosis has been accepted.

Once the treatment protocol is identified at step 310, the system 100 identifies an action item at step 312 to begin the treatment of the diagnosed patient. The action item may be identified by reference to the predetermined diagnosis and treatment profiles stored on the system 100. At step 314, the system displays the action item on one or more of the user devices 106, 108, 110 and at step 316 the system sets a countdown timer for one of the members of the medical team to complete the identified action item within a target timeframe. Optionally, the countdown timer is also displayed at step 314. The countdown timer value may be identified by reference to the predetermined diagnosis and treatment profiles stored on the system 100, and may vary from action item to action item. The value of the countdown timer should be set to define a realistic time duration for a reasonably diligent medical team to complete the action item in expected working conditions and may also depend on the severity of the patient conditions being treated.

As illustrated at steps 318 and 320, the system 100 awaits user confirmation at step 318 that the action item has been completed while also checking to see whether or not the countdown timer has expired. Any member of the medical team may confirm completion of the action item using the input elements of one or more of the user devices 106, 108, 110. Since one of the goals of the system is to avoid expiration of time limits for completing action items, the system 100 may optionally provide increasingly urgent prompts to the patient provider team and/or a system dashboard operator as an activity comes closer to being past due (i.e., as the countdown timer nears expiration).

If the countdown timer expires before the user confirmation is made, the system 100 generates an alert as shown at step 322. The alert may be sent the management devices 112 and/or administrator devices 112, 114 in the system 100. Real time identification of the missed timeline for completing an action item is made to the appropriate persons so that corrective actions may be taken. The alert may be delivered in any form desired, including but not limited to phone calls, SMS text messages, push notifications, email messages, facsimiles, etc. Other optional steps taken by the system 100 may including highlighting the action items on the user devices 106, 108, 110, presenting message pop-ups or windows on the user devices 106, 108, 110 and setting another countdown timer for completion of the action item. Escalating alerts may be sent to different devices and persons if the action item is not timely resolved.

In some embodiments and for certain action items the system 100 may optionally ascertain completion of action items via data abstraction, and as such certain action items may be confirmed as completed by the system instead of needing confirmation by a system user. For example, if the action item needing to be taken is to administer a medication, obtain an x-ray, or perform a lab test and the health record indicates such medication has been provided, that an x-ray exists or that a lab test result has been delivered the system need not rely upon user confirmation to know that these action items have been completed.

If completion of the action item is confirmed before the countdown timer expires, the system determines if another action item is required to complete the identified protocol at step 310. If so, the next action item is displayed at step 326 and the system 100 returns to step 314 to display the next action item and sets a countdown timer for the next action item at step 316. If there is not another action item required to complete the identified protocol, completion of the protocol is displayed at step 328. The system 100 records the time of each action item completion and any alerts generated.

It should be understood that the steps described above are simultaneously being processed by the system 100 across a number of patients being evaluated and treated. That is, at a given point in time the dashboards of the user devices 106, 108, 110 may include action items for multiple patients with different countdown timers applying to each action item.

As shown at step 330, if the possible patient diagnosis is not confirmed by a user, the system at step 330 records an exception that can be considered for identification of a future possible diagnosis of the same patient or another patient. As such, the system 100 can intelligently learn from a member of the medical team that rejects the possible patient diagnosis presented at step 306, particularly so when the member of the medical team inputs an alternative diagnosis. The system 100 in general seeks to reduce the number of exceptions to zero such that the system operates in the least obtrusive manner possible to the medical team. Also, and as desired, systems users may optionally request or see detailed information or explanation why the system presented the possible patient diagnosis in the first place so that users may have a better feel for how the system is making its recommendations. Likewise, system users may provide comments in return reasons why the diagnosis identified by the system was rejected. Such comments may be particularly valuable from the perspective of revising the predetermined diagnosis and treatment profiles on the system to avoid false positives in making diagnoses.

Over time, such exceptions generated by the system 100 can be expected to become fewer and fewer because the system 100 may adaptively reduce, if not eliminate, false positives in identifying possible patient diagnoses at step 306. Self-learning rules and sub-rules may be adopted by the system to eliminate false positives in view of feedback from the system users. As such, and in view of the medical team accepting or rejecting identified possible patient diagnoses on previous occasions under similar circumstances, the system 100 may eliminate what otherwise appear to be matches between an analyzed health care record and one of the predetermined diagnosis and treatment profiles stored on the system, or intelligently choose between two or profiles that otherwise appear to present matches. The system 100, by considering such acceptances or rejections in addition to the contents of the health care record being analyzed and the predetermined diagnosis and treatment profiles stored on the system, will become progressively better at making accurate diagnoses and corresponding selection or identification of the applicable treatment protocol, and the confidence of the medical team using the system 100 may increase.

On the other hand, an excessive number of exceptions at step 330 may provide a reason to troubleshoot the system and/or optimize the predetermined diagnosis and treatment profiles stored on the system to reduce the number of exceptions. The system 100 may record the times of user confirmation or rejection, and possibly which member of the medical team confirmed or rejected the diagnosis identified by the system 100 for later report generation and analysis by facility managers or administrators.

As shown at step 332, the system 100 further sets a countdown timer that triggers a re-analysis of the health care record(s) at a subsequent point in time. That is, when the countdown timer expires at step 334 the system 100 returns to step 302 and again analysis the health care record(s) for each patient that is present. This allows the system 100 to account for changes in the analyzed health care record(s) over time that may affect the recommended diagnosis and action items for a treatment protocol. As shown at step 336, if a material change in the health care record analysis is found, the system 100 may generate an alert at step 338 to the users of the devices 106, 108, 110, 112 or 114 and proceed to step 304 to identify another and alternative possible patient diagnosis in view of changes in the health care record of one or more patients over time. The alternative patient diagnosis may then be confirmed or rejected at step 308 and the process continues as described above. The countdown timer at step 332 may, for example, be every few minutes so that any corrections to the patient diagnoses and/or the treatment protocols can quickly be made by the medical team as new, material information emerges in the electronic health care records.

If there are not material changes in the re-analysis at step 336, the system continues with the previously determined diagnoses and any treatment protocol being performed. The system returns to set the countdown timer at step 322 and continues the process described above.

It is recognized that any patient may have more than one condition needing different diagnoses and treatments that can be presented individually or in combination for confirmation by medical personnel in the system 100. The re-analysis of the record at the expiration of the timer at steps 332, 334 may therefore, in addition to revealing an alternative diagnosis to one previously made, reveal an additional diagnosis that could not have been identified before a change in the health care record was made. The system 100 is fully capable of diagnosing and guiding the medical team to treat multiple conditions of the same patient, as well as groups of patients having more than one condition needing treatment.

The system 100 may also iteratively comb through electronic health care records of the same patient or different patients to identify potential core measure patients or core measure action items to guide the medical team through the applicable steps. Improvements in composite scores for a payment provider may accordingly be improved and efficacy of treatments can easily be demonstrated using the data collected by the system.

The system 100 and process 300 may also include a failsafe interrupt feature in which a member of the medical team may interrupt system operation completely if needed.

The system 100 and process 300 can beneficially generate reports on core measures and fall out, and automatically implement record keeping for efficacy and compliance purposes.

Each medical treatment facility can set its own metrics for the countdown timers described in relation to each treatment protocol being performed or action items needing to be taken, or otherwise may use standardized timing goals. Any number of dashboards may be provided with different rules implementing the functions described to meet different needs. For examples, floor 1 rules may be different than floor 2, even when otherwise similar action items are involved. More specifically, the values of the countdown timers invoked in the rules of floor 1 may be less that the values of the countdown timers invoked in the rules of floor 2 to reflect different urgencies of conditions. Different rules can also be invoked for different treatment events, whether or not location-based. For instance, different patients on the same floor may be subject to different rules having different countdown timers for the same or different action items.

The systems and processes described above will now be briefly explained in relation to specific examples of particular conditions and action items that can be coordinated in the system 100.

### Example 1: Patient with Long Bone Fracture in an Emergency Department/Room of a Medical Treatment Facility

To identify the patient condition in Example 1, the system 100 may search the medical record for a patient complaint or symptom consistent with a long bone fracture and/or an indication of a patient exam or procedure relating to possible long bone fracture, including but not limited to an examination note, an x-ray order, an x-ray interpretation, that certain medications have been ordered or administered, etc. The system 100 may specifically take note of any test in the record that references one or more of the following terms: fall, wrist pain, trauma, deformity, forearm pain, swelling, leg pain, splint, elbow pain. As described above, in some embodiments that system may specifically look for ICD9/ICD10 entries of the International Classification of Diseases (ICD) in the record. A patient may be flagged as having such condition when x-rays of long bones ordered or have x-ray interpretations which show such a fracture. X-rays orders may include one of the following terms: forearm, humerus, elbow, wrist, femur, tibia, fibula that may be identified by the systems and processes described.

Once the long bone fracture patient has been identified, the system may identify a treatment protocol including the following action items to be completed in desired timeframe(s). A timer may be retroactively started at the time of the patient's arrival in the medical facility, and the medical team may be prompted to administer predetermined medications. As the timer expires, if no medication has been administered, or if the medication has been refused by the patient, notifications may be generated on any of the system dashboards, and a system alert may be generated to managers or administrators of the Emergency Department/Room of a medical treatment facility or mangers or administrators of the larger medical treatment facility. The system may time and confirm each of these actions to completion.

### Example 2: Patient with Acute Myocardial Infarction

To identify the patient condition in Example 2, the system may look for one or more of the following in the patient's electronic health care record: specific ICD9/10 entries or “chest pain” in a text field.

Once the Acute Myocardial Infarction condition has been identified, the system may identify a treatment protocol including the following action items to be completed in desired timeframe(s). Aspirin must be given on arrival. TNK (blood clot dissolver) must be provided within 30 minutes if no plan for angiogram exists. An Angiogram (PCI) should be completed within 90 minutes. For patient discharge, Aspirin and Statins should be prescribed, and additional medications should also be described if an echocardiogram reveals left ventricle dysfunction. The system may time and confirm each of these actions to completion.

### Example 3: Patient with Venous Thromboembolism

To identify the patient condition in Example 3, the system may look for one or more of the following in the patient's electronic health care record: references to “blood clot” or “blood clots” in a text field, and/or indications of measures to prevent blood clots with no contraindications.

Once the Acute Myocardial Infarction condition has been identified, the system may identify a treatment protocol including the following action items to be completed in desired timeframe(s). Compression devices and medications need to be applied, the patient should be monitored and preventative measures taken to detect or prevent blood clots in legs. At discharge, instructions must include instructions to prevent further blood clots. Patients on heparin should have platelets checked, and patients with blood clots should receive 2 medications for thinning blood. The system may time and confirm each of these actions to completion.

### Example 4: Patient Needing Influenza Vaccination Screening & Administration

To identify the patient condition in Example 4, the system may look for one or more of the following in the patient's electronic health care record: indications of previous vaccination, Abstract data from immunization screening tool, or qualifying patient being 6 months and older discharged during months of October-March.

Once the patient condition in Example 4 has been identified, the system may identify the following action items to be completed in desired timeframe(s): administration of Influenza vaccination if not previously administered: possible Pneumococcal vaccination screen for patient older than 65, or a high-risk patient aged 6-64. The system may time and confirm each of these actions to completion.

### Example 5: Stroke Patient

To identify the patient condition in Example 5, the system may look for one or more of the following in the patient's electronic health care record: keywords including CVA, (cerebro vascular accident), TIA (transient ischemic attack), stroke, or specific ICD 9/10 codes.

Once the patient condition in Example 5 has been identified the system may identify the following action items to be completed in desired timeframe(s): blood clot prevent measures; discharge with specific blood thinners; blood thinners if patient is also diagnosed with atrial fibrillation or atrial flutter, discharge on medication for cholesterol (statin), stroke education, and assessment for rehabilitation/PT/OT. The system may time and confirm each of these actions to completion.

### Example 6: Patient with Severe Septis

To identify the patient condition in Example 6, the system may look for one or more of the following in the patient's electronic health care record: Must meet 2 at least two of the following criteria and have suspected infection for SEPSIS (Temperature>101 or <96.8, Pulse >90, Resp rate >20, White blood count >12,000 or <4,000, White blood bandemia >10%); any reference to SEVERE SEPSIS, SEPSIS+organ dysfunction, SBP<90, MAP <&, Creatinine >2.0, Urine output <0.5 ml/kg/hour (not used much), Bilirubin >2.0. Platelet <100,000. INR >1.5 (blood test), Altered mental status, LACTATE >2.0, SEPTIC SHOCK (defined as lactate >4 OR low blood pressure after IV fluids).

Once the patient condition in Example 6 has been identified the system may identify the following action items to be completed in desired timeframe(s): If Severe Septis indicated (by rules above) then within 3 hours of presentation Check lactate, Obtain blood cultures and Administer antibiotics and within 6 hours, repeat lactate if initial lactate >2; If Septic Shock indicates (by rules above), then within 3 hours, Measure lactate, Obtain blood cultures, Administer antibiotics, Give IV fluids and within 6 hours repeat volume status assessment (complicated criteria) and Administer vasopressor. The system may time and confirm each of these actions to completion.

Having now described the system and processes functionally, the programming of the devices described to implement the systems and processes described is believed to be within the purview of those in the art and no further explanation is provided.

The versatility and flexibility of the inventive systems to effectively aid in diagnosis and treatment of various conditions with beneficial results is now believed to have been amply illustrated from the exemplary embodiments disclosed.

An embodiment of a health care record analytic and medical treatment protocol system has been disclosed, including at least one processor-based device configured to: analyze an electronic health care record of at least one patient at a first point in time, identify a medical treatment action item in view of the analyzed electronic health care record, and prompt a user confirmation of the identified medical treatment action item. If the identified medical treatment action item is confirmed, the at least one processor-based device is also configured to: set a countdown timer for performance of the identified medical treatment action item, and await user confirmation that the identified medical treatment action item is completed before the expiration of the countdown timer.

Optionally, the at least one processor-based device may also be configured to: accept the user confirmation that the identified medical treatment action item is complete, and determine whether another medical treatment action item needs to be performed after the completed medical treatment action item. When another medical treatment action item needs to be performed, the at least one processor-based device may further be configured to: identify a next medical treatment action item to be performed; set a countdown timer for performance of the next medical treatment action item; and await user confirmation that the next medical treatment action item is completed before the expiration of the countdown timer. When another medical treatment action item does not need to be performed, the at least one processor-based device may further be configured to provide a user confirmation that a patient treatment protocol is complete.

The at least one processor-based device may further be configured to: when the user confirmation that the identified medical treatment action item is complete is not received before the expiration of the countdown timer, generate an alert.

The identified medical treatment action item may be one of a diagnosis of a patient condition or a step of a treatment protocol for a diagnosed patient condition.

If the identified medical treatment action item is not confirmed, the at least one processor-based device may be configured to generate an exception record, and consider the exception record when identifying a future medical treatment action item from an analyzed electronic health care record. The at least one processor-based device may be a server device, and the at least one processor-based device may be in communication with a separate electronic health care record system. The at least one processor-based device may retrieve the electronic health care record from the electronic health care record system.

The system may include a plurality of display screens associated with the at least one processor-based device, with each of the plurality of screens displaying identified medical treatment action items for a plurality of different patients.

The at least one processor-based device may further be configured to analyze the electronic health care record of at least one patient at a second point in time subsequent to the first time, identify a medical treatment action item from the analyzed electronic health care record at the second point in time, and compare the identified medical treatment action item from the second point in time to the identified medical treatment action item from the first point in time. If the identified medical treatment action item from the second point in time is different to the identified medical treatment action item from the first point in time, the at least one processor-based device may further be configured to: generate an alert for user confirmation of the identified medical treatment action item from the second point in time. If the identified medical treatment action item from the second point in time is the same as the identified medical treatment action item from the first point in time, the at least one processor-based device may further be configured to continue the countdown timer for performance of the identified medical treatment action item and await user confirmation that the identified medical treatment action item is complete before the expiration of the countdown timer.

The at least one processor-based device may be configured to generate a compliance report for identified medical treatment action items that are completed before the expiration of the countdown timer, and may be configured to generate a management report for identified medical treatment action items that are not completed before the expiration of the countdown timer.

An embodiment of a health care record analytic and medical treatment protocol method has also been disclosed. The method is implemented with at least one processor-based device, and the method includes analyzing, by the at least one processor-based device, an electronic health care record of at least one patient at a first point in time, identifying a medical treatment action item in view of the analyzed electronic health care record and prompting a user confirmation of the identified medical treatment action item. If the identified medical treatment action item is confirmed, the method further comprises setting a countdown timer for performance of the identified medical treatment action item, and awaiting user confirmation that the identified medical treatment action item is completed before the expiration of the countdown timer.

Optionally, the method may also include accepting the user confirmation that the identified medical treatment action item is complete, and determining, by the at least one processor-based device, whether another medical treatment action item needs to be performed after the completed medical treatment action item.

When another medical treatment action item needs to be performed, the method may include identifying, by the at least one processor-based device, a next medical treatment action item to be performed, setting a countdown timer for performance of the next medical treatment action item, and awaiting user confirmation that the next medical treatment action item is completed before the expiration of the countdown timer. When another medical treatment action item does not need to be performed, the method may include providing a user confirmation that a patient treatment protocol is complete.

When the user confirmation that the identified medical treatment action item is complete is not received before the expiration of the countdown timer, the method may include generating an alert.

If the identified medical treatment action item is not confirmed, the method may include generating, by the at least one processor-based device, an exception record, and considering the exception record when identifying a future medical treatment action item from an analyzed electronic health care record.

The method may include retrieving the electronic health care record from a separately provided electronic health care record system.

The method may also include analyzing, by the at least one processor-based device the electronic health care record of at least one patient at a second point in time subsequent to the first time, identifying a medical treatment action item from the analyzed electronic health care record at the second point in time, and comparing the identified medical treatment action item from the second point in time to the identified medical treatment action item from the first point in time. If the identified medical treatment action item from the second point in time is different to the identified medical treatment action item from the first point in time, the method may include generating an alert for user confirmation of the identified medical treatment action item from the second point in time. If the identified medical treatment action item from the second point in time is the same as the identified medical treatment action item from the first point in time, the method may include continuing the countdown timer for performance of the identified medical treatment action item and awaiting user confirmation that the identified medical treatment action item is complete before the expiration of the countdown timer.

The method may also include generating a compliance report for identified medical treatment action items that are completed before the expiration of the countdown timer, and generating a management report for identified medical treatment action items that are not completed before the expiration of the countdown timer.

An embodiment of a non-transitory computer readable medium that includes computer executable instructions for electronically analyzing patient health care records and performance of medical treatment protocols has also been disclosed. When executed by at least one computing device having at least one processor in communication with a memory device, the computer executable instructions cause the at least one computing device to analyze an electronic health care record of at least one patient at a first point in time, identify a medical treatment action item in view of the analyzed electronic health care record, and prompt a user confirmation of the identified medical treatment action item. If the identified medical treatment action item is confirmed, the computer executable instructions also cause the at least one computing device to set a countdown timer for performance of the identified medical treatment action item, and await user confirmation that the identified medical treatment action item is completed before the expiration of the countdown timer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A health care record analytic and medical treatment protocol system comprising:
at least one processor-based device configured to:
analyze an electronic health care record of at least one patient at a first point in time;
identify a medical treatment action item in view of the analyzed electronic health care record;
prompt a user confirmation of the identified medical treatment action item; and
if the identified medical treatment action item is confirmed:
set a countdown timer for performance of the identified medical treatment action item; and
await user confirmation that the identified medical treatment action item is completed before the expiration of the countdown timer.

2. The system of claim 1, wherein the at least one processor-based device is further configured to:
accept the user confirmation that the identified medical treatment action item is complete, and
determine whether another medical treatment action item needs to be performed after the completed medical treatment action item.

3. The system of claim 2, wherein the at least one processor-based device is further configured to:
when another medical treatment action item needs to be performed, identify a next medical treatment action item to be performed;
set a countdown timer for performance of the next medical treatment action item; and
await user confirmation that the next medical treatment action item is completed before the expiration of the countdown timer.

4. The system of claim 2, wherein the at least one processor-based device is further configured to:
when another medical treatment action item does not need to be performed, provide a user confirmation that a patient treatment protocol is complete.

5. The system of claim 1, wherein the at least one processor-based device is further configured to:
when the user confirmation that the identified medical treatment action item is complete is not received before the expiration of the countdown timer, generate an alert.

6. The system of claim 1, wherein the identified medical treatment action item is one of a diagnosis of a patient condition or a step of a treatment protocol for a diagnosed patient condition.

7. The system of claim 1, wherein if the identified medical treatment action item is not confirmed, the at least one processor-based device is configured to:
generate an exception record; and
consider the exception record when identifying a future medical treatment action item from an analyzed electronic health care record.

8. The system of claim 1, wherein the at least one processor-based device comprises a server device.

9. The system of claim 1, wherein the at least one processor-based device is in communication with a separate electronic health care record system, and the at least one processor-based device retrieving the electronic health care record from the electronic health care record system.

10. The system of claim 1, further comprising a plurality of display screens associated with the at least one processor-based device, each of the plurality of screens displaying identified medical treatment action items for a plurality of different patients.

11. The system of claim 1, wherein the at least one processor-based device is further configured to:
analyze the electronic health care record of at least one patient at a second point in time subsequent to the first time;
identify a medical treatment action item from the analyzed electronic health care record at the second point in time; and
compare the identified medical treatment action item from the second point in time to the identified medical treatment action item from the first point in time.

12. The system of claim 11, wherein if the identified medical treatment action item from the second point in time is different to the identified medical treatment action item from the first point in time, generate an alert for user confirmation of the identified medical treatment action item from the second point in time.

13. The system of claim 11, wherein if the identified medical treatment action item from the second point in time is the same as the identified medical treatment action item from the first point in time, continue the countdown timer for performance of the identified medical treatment action item and await user confirmation that the identified medical treatment action item is complete before the expiration of the countdown timer.

14. The system of claim 1, wherein the at least one processor-based device is further configured to generate a compliance report for identified medical treatment action items that are completed before the expiration of the countdown timer.

15. The system of claim 1, wherein the at least one processor-based device is further configured to generate a management report for identified medical treatment action items that are not completed before the expiration of the countdown timer.

16. A health care record analytic and medical treatment protocol method, the method implemented with at least one processor-based device, the method comprising:
analyzing, by the at least one processor-based device, an electronic health care record of at least one patient at a first point in time;
identifying a medical treatment action item in view of the analyzed electronic health care record;
prompting a user confirmation of the identified medical treatment action item; and
if the identified medical treatment action item is confirmed:
setting a countdown timer for performance of the identified medical treatment action item; and
awaiting user confirmation that the identified medical treatment action item is completed before the expiration of the countdown timer.

17. The method of claim 16, further comprising:
accepting the user confirmation that the identified medical treatment action item is complete, and
determining, by the at least one processor-based device, whether another medical treatment action item needs to be performed after the completed medical treatment action item.

18. The method of claim 17, further comprising:
when another medical treatment action item needs to be performed:
identifying, by the at least one processor-based device, a next medical treatment action item to be performed;
setting a countdown timer for performance of the next medical treatment action item; and
awaiting user confirmation that the next medical treatment action item is completed before the expiration of the countdown timer.

19. The method of claim 17, further comprising:
when another medical treatment action item does not need to be performed, providing a user confirmation that a patient treatment protocol is complete.

20. The method of claim 16, further comprising:
when the user confirmation that the identified medical treatment action item is complete is not received before the expiration of the countdown timer, generating an alert.

21. The method of claim 16, wherein if the identified medical treatment action item is not confirmed, the method comprises:
generating, by the at least one processor-based device, an exception record; and
considering the exception record when identifying a future medical treatment action item from an analyzed electronic health care record.

22. The method of claim 16, further comprising retrieving the electronic health care record from a separately provided electronic health care record system.

23. The method of claim 16, further comprising:
analyzing, by the at least one processor-based device the electronic health care record of at least one patient at a second point in time subsequent to the first time;
identifying a medical treatment action item from the analyzed electronic health care record at the second point in time; and
comparing the identified medical treatment action item from the second point in time to the identified medical treatment action item from the first point in time.

24. The method of claim 23, wherein if the identified medical treatment action item from the second point in time is different to the identified medical treatment action item from the first point in time, the method further comprises generating an alert for user confirmation of the identified medical treatment action item from the second point in time.

25. The method of claim 16, wherein if the identified medical treatment action item from the second point in time is the same as the identified medical treatment action item from the first point in time, the method comprises continuing the countdown timer for performance of the identified medical treatment action item and awaiting user confirmation that the identified medical treatment action item is complete before the expiration of the countdown timer.

26. The method of claim 16, further comprising generating a compliance report for identified medical treatment action items that are completed before the expiration of the countdown timer.

27. The method of claim 16, further comprising generating a management report for identified medical treatment action items that are not completed before the expiration of the countdown timer.

28. A non-transitory computer readable medium that includes computer executable instructions for electronically analyzing patient health care records and performance of medical treatment protocols, wherein when executed by at least one computing device having at least one processor in communication with a memory device, the computer executable instructions cause the at least one computing device to:
analyze an electronic health care record of at least one patient at a first point in time;
identify a medical treatment action item in view of the analyzed electronic health care record;
prompt a user confirmation of the identified medical treatment action item; and
if the identified medical treatment action item is confirmed:
set a countdown timer for performance of the identified medical treatment action item; and
await user confirmation that the identified medical treatment action item is completed before the expiration of the countdown timer.
